(19) United States
(12) Patent Application Publication
(10) Pub. No.: US 2012/0274069 A1
(43) Pub. Date: Nov. 1, 2012

(54) DUAL FLUID CIRCUIT SYSTEM FOR GENERATING A VAPOROUS WORKING FLUID USING SOLAR ENERGY

(75) Inventors: Milton Venetos, Los Altos, CA (US); Thomas Caulfield, Pleasanton, CA (US); William M. Conlon, Palo Alto, CA (US); Robert Brown Callery, Saratoga, CA (US)

(73) Assignee: AREVA Solar, Inc., Mountain View, CA (US)

(21) Appl. No.: 13/505,245

(22) PCT Filed: Oct. 29, 2010
(86) PCT No.: PCT/US10/54855

§ 371 Date: Jul. 11, 2012

Related U.S. Application Data
(60) Provisional application No. 61/256,814, filed on Oct. 30, 2009.

(51) Int. Cl. F24J 2/30; F03G 6/00; H02K 7/18; F24J 2/00

(52) U.S. Cl. 290/52; 126/643; 126/714; 60/641.8

(57) ABSTRACT

Systems for producing vaporous working fluid are provided, including: a first fluid passage configured to convey a working fluid to a first solar heating system, wherein the first solar heating system heats the working fluid to produce a heated working fluid having a temperature t₁ and a quality X₁; a second fluid passage configured to convey a heat transfer fluid to a second solar heating system to produce a heated heat transfer fluid; and a heat exchanger configured to transfer heat from the heated heat transfer fluid to the heated working fluid. When X₁<1, the heat transfer results in an increase in quality of the heated working fluid When X₁=1, the heat transfer results in an increase in temperature of the heated working fluid. Methods of using the systems to produce vaporous working fluid are also provided.

### RELATED APPLICATIONS

This application claims the benefit of priority from U.S. provisional patent application entitled “Dual Fluid Circuit System for Generating a Vaporous Working Fluid Using Solar Energy”, application Ser. No. 61/256,814, inventors Milton Venetos, Thomas Caulfield, William M. Conlon, and Robert Brown Callery, filed on Oct. 30, 2009, which is hereby incorporated by reference in its entirety for all purposes as if put forth in full below.

### BACKGROUND

1. Field:

The present disclosure relates generally to solar-powered heating systems and methods for producing a vaporous working fluid, and facilities incorporating such systems, such as electrical power generators and facilities using industrial process steam.

2. Related Art:

Alternate sources of energy are needed to continue supplying a source of energy for many processes to accommodate an ever-increasing population world-wide. Solar energy is readily available in certain geographic areas and can be used to perform work or provide heat for use in many industrial processes.

While solar energy may be converted to electricity directly in solar panels by absorbing some of the light incident on solar panels, the heat available from solar energy may be harnessed and used to increase temperature and optionally pressure of a working fluid such as water to supply high-temperature working fluid. The technology described herein provides systems for heating the working fluid to drive industrial processes, such as rotate a turbine for electrical power generation, or for direct use in industrial processes such as process steam. An increased quality and/or temperature of working fluid, e.g., an increased quality of steam or a steam of higher temperature, may be beneficial in certain applications. For example, turbines may be more efficiently driven using a superheated vaporous working fluid (such as superheated steam) as opposed to a lower temperature working fluid (e.g., a lower temperature superheated steam or saturated steam).

U.S. Patent Publications US 2004/0035111, US 2008/0302314, US 2008/0029150, US 2008/0184789, and US 2009/0101138, and U.S. Pat. No. 7,296,410 each disclose various methods for producing a heated working fluid by means of solar energy.

All of the publications and other references mentioned in this document are incorporated by reference in their entirety for all that they disclose and are therefore to be read as if put forth in full below to the extent that the teaching of an individual reference does not conflict with what is otherwise taught herein.

### BRIEF SUMMARY

Systems, methods, and apparatus by which solar energy may be collected as heat and used to heat a working fluid are disclosed herein.

In one aspect of the present disclosure is a system for producing a vaporous working fluid, comprising: a) a first fluid passage configured to convey a working fluid to a first solar heating system, wherein the first solar heating system heats the working fluid to produce a heated working fluid having a temperature t₁ and a quality x₁; b) a second fluid passage configured to convey a heat transfer fluid to a second solar heating system to produce a heated heat transfer fluid; and c) a heat exchanger configured to transfer heat from the heated heat transfer fluid to the heated working fluid, wherein when x₁ <1, the heat transfer results in an increase in quality of the heated working fluid to a quality x₂, wherein x₂>x₁; and wherein when x₁=1, the heat transfer results in an increase in the temperature of the heated working fluid to a temperature t₂, wherein t₂>t₁. In some embodiments, the system further comprises a separator located in circuit between the first solar heating system and the heat exchanger, wherein the separator is configured to receive the heated working fluid having quality x₁ from the first solar heating system, wherein the separator separates at least a portion of the liquid working fluid, if present, from the heated working fluid, whereby the quality of the heated working fluid is increased to x₁′; and wherein the heat exchanger is configured to receive the heated working fluid having quality x₁′ from the separator and operates to transfer heat from the heated heat transfer fluid to the heated working fluid, wherein when x₁′<1, the heat transfer results in an increase in quality of the heated working fluid to a quality x₂, wherein x₂>x₁′; and wherein when x₁′=1, the heat transfer results in an increase in the temperature of the heated working fluid to a temperature t₂, wherein t₂>t₁. In some embodiments, wherein x₁<1. In some embodiments, x₁′ is at least about 0.95. In some embodiments, x₁′=1. In some embodiments, x₂=1. In some embodiments, x₁<1, and wherein the heat transfer results in an increase in the temperature of the heated working fluid to a temperature t₂, wherein t₂>t₁. In some embodiments, x₁ is about 0.4 to about 0.9, wherein x₁′ is at least about 0.95, wherein x₂=1, and wherein the heat transfer results in an increase in the temperature of the heated working fluid to a temperature t₂, wherein t₂>t₁. In some embodiments, the working fluid is water. In some embodiments, the heat transfer fluid is selected from the group consisting of: an oil, a molten salt, a molten mixture of salts, and an organic synthetic heat transfer fluid. In some embodiments, the working fluid is water and the heat transfer fluid is an organic synthetic heat transfer fluid.

In another aspect of the present disclosure is a system for producing a superheated working fluid comprising: a) a first fluid passage configured to convey a working fluid to a first solar heating system, wherein the first solar heating system heats the working fluid to produce a heated working fluid, wherein the heated working fluid comprises a vapor; b) a second fluid passage configured to convey a heat transfer fluid to a second solar heating system to produce a heated heat transfer fluid; and c) a heat exchanger configured to transfer heat from the heated heat transfer fluid to the heated working fluid received from the first solar heating system, wherein the heated working fluid is heated to produce a superheated working fluid. In some embodiments, the system further comprises a separator configured to receive the heated working fluid from the first solar heating system, wherein the separator preferentially separates vaporous working fluid from liquid working fluid and delivers the vaporous working fluid to the heat exchanger where the vaporous working fluid is heated to produce a superheated working fluid. In some embodiments, the first solar heating system comprises a linear Fresnel solar heating system. In some embodiments, the linear Fresnel solar heating system comprises a single-tube receiver structure. In some embodiments, the linear Fresnel solar heating system comprises a multi-tube receiver structure. In some embodiments, the second solar heating system comprises a parabolic trough solar heating system. In some embodiments, the second solar heating system comprises a linear Fresnel solar heating system. In some embodiments, the first solar heating system comprises a linear Fresnel solar heating system and the second solar heating system comprises a parabolic trough solar heating system. In some embodiments, the first solar heating system comprises a linear Fresnel solar heating system and the second solar heating system comprises a linear Fresnel solar heating system. In some embodiments, the linear Fresnel solar heating system comprises a single-tube receiver structure. In some embodiments, the linear Fresnel solar heating system comprises a multi-tube receiver structure. In some embodiments, the first solar heating system and the second solar heating system are the same system. In some embodiments, the first solar heating system and the second solar heating system are separate systems. In some embodiments, a third fluid passage conveys the working fluid to the second solar heating system. In some embodiments, the second solar heating system heats the working fluid to produce a preheated working fluid, and wherein the first fluid passage is configured to receive the preheated working fluid. In some embodiments, the second solar heating system heats the working fluid to produce heated working fluid, and wherein the separator is configured to receive the heated working fluid from the second solar heating system. In some embodiments, the second solar heating system comprises a linear Fresnel solar heating system comprising a multi-tube receiver comprising a plurality of receiver tubes arranged side by side, wherein one or more receiver tubes configured for carrying the heat transfer fluid, and one or more receiver tubes configured for carrying the working fluid are arranged such that the one or more receiver tubes configured for carrying the heat transfer fluid receive peak solar power distribution during operation of the second solar heating system. In some embodiments, the working fluid is water. In some embodiments, the working fluid comprises ammonia. In some embodiments, the heat transfer fluid is a sensible heating fluid. In some embodiments, the heat transfer fluid does not undergo a phase change during heating. In some embodiments, the heat transfer fluid is selected from the group consisting of: an oil, a molten salt, a molten mixture of salts, an ionic liquid, and a synthetic organic heat transfer fluid. In some embodiments, the working fluid is water and the heat transfer fluid is a synthetic organic heat transfer fluid. In some embodiments, a first thermal energy storage system is arranged in circuit between the separator and the heat exchanger, and is configured to store thermal energy from the vaporous working fluid. In some embodiments, a second thermal energy storage system is arranged in circuit between the second solar heating system and the heat exchanger, and is configured to store thermal energy from the heated heat transfer fluid.

In some embodiments of the systems described above, the system further comprises a turbine, wherein the turbine is configured to receive the vaporous working fluid (e.g., superheated working fluid) for rotating the turbine. In some embodiments, after passage through a portion of the turbine, the temperature of the vaporous working fluid has fallen to produce a partially cooled working fluid, wherein the system further comprises a fourth fluid passage configured to convey the partially cooled working fluid to a reheater heat exchanger, wherein the reheater heat exchanger is configured to transfer heat from the heated heat transfer fluid to the partially cooled working fluid to produce a reheated working fluid, and wherein the reheated working fluid is delivered to the turbine for rotating the turbine. In some embodiments, the system further comprises an electrical generator coupled to the turbine. In some embodiments, the system is configured for direct utilization of the vaporous working fluid. In some embodiments, the vaporous working fluid is a superheated working fluid.

In another aspect of the present disclosure is a method of producing a vaporous working fluid, comprising use of a system as described herein. In another aspect of the present disclosure is a method of producing a superheated working fluid, comprising use of a system as described herein.

In another aspect of the present disclosure is a method of producing electrical energy, comprising use of a system as described herein.

In another aspect of the present disclosure is a method for producing a vaporous working fluid, the method comprising: a) heating a working fluid with a first solar heating system to produce a first working fluid stream having a quality x₁ and a temperature t₁; b) heating a heat transfer fluid with a second solar heating system to produce a first heat transfer fluid stream; and c) transferring heat from the first heat transfer fluid stream to the first working fluid stream; wherein when x₁<1, the heat transfer results in production of an output working fluid stream having a quality x₂, wherein x₂>x₁; and wherein when x₁=1, the heat transfer results in production of an output working fluid stream having a temperature t₂, wherein t₂>t₁. In some embodiments, the methods comprises preferentially selecting vapor from the first working fluid stream to form a second working fluid stream having quality x₁′, and transferring heat from the first heat transfer fluid stream to heat the second working fluid stream, wherein when x₁′<1, the heat transfer results in an increase in quality of the output working fluid stream to a quality x₂, wherein x₂>x₁′; and wherein when x₁′=1, the heat transfer results in an increase in the temperature of the heated working fluid to a temperature t₂, wherein t₂>t₁. In some embodiments, the working fluid is water. In some embodiments, the heat transfer fluid is selected from the group consisting of: an oil, a molten salt, a mixture of molten salts, and a synthetic organic heat transfer fluid. In some embodiments, the heat transfer fluid does not undergo a phase change during heating. In some embodiments, the first solar heating system comprises a Linear Fresnel solar heating system. In some embodiments, the second solar heating system comprises a parabolic trough solar heating system. In some embodiments, the first solar heating system comprises a linear Fresnel solar heating system and the second solar heating system comprises a parabolic trough solar heating system. In some embodiments, the first solar heating system comprises a linear Fresnel solar heating system and the second solar heating system comprises a linear Fresnel solar heating system. In some embodiments, the working fluid is water and the heat transfer fluid is a synthetic organic heat transfer fluid. In some embodiments, x₂=1. In some embodiments, the output vaporous working fluid is superheated steam at a pressure of about 100 bar and about 370° C.

### BRIEF DESCRIPTION OF THE DRAWINGS

FIG. 1 is a schematic illustration of an example of an embodiment of a system for producing a vaporous working fluid.

FIG. 2 is a schematic illustration of another example of an embodiment of a system for producing a vaporous working fluid.

FIG. 3 is a schematic illustration of another example of an embodiment of a system for producing a vaporous working fluid.

FIG. 4 shows a perspective view of an exemplary linear Fresnel solar energy collector system comprising a multi-tube solar thermal receiver.

FIG. 5 shows a cross-section of an exemplary multi-tube solar thermal receiver and a plot of an exemplary concentrated solar radiation distribution across the section.

### DETAILED DESCRIPTION

The following detailed description should be read with reference to the drawings, in which identical reference numbers refer to like elements throughout the different figures. The drawings, which are not necessarily to scale, depict selective embodiments and are not intended to be limiting. The detailed description illustrates by way of example, not by way of limitation, the principles of the present technology. This description will clearly enable one skilled in the art to make and use the various embodiments, and describes several embodiments, adaptations, variations, alternatives and uses of the present technology, including what is presently believed to be the best mode of carrying out the present technology.

As used in this specification and the appended claims, the singular forms “a,” “an,” and “the” include plural referents unless the context clearly indicates otherwise.

The quality of a working fluid x=(h−h_{f})/h_{fg}, where h=the enthalpy of the fluid produced, h_{f}=the enthalpy of the saturated liquid, h_{g}=the enthalpy of the saturated vapor, and h_{fg}=h_{g}−h_{f}=the difference between enthalpies of saturated vapor and saturated liquid. Where x=0, the working fluid is 100% liquid. Where 0<x<1, vapor and liquid are present in a saturated state, and x is an indication of the proportion of saturated vapor in a vapor/liquid (e.g., steam/water) mixture. Increasing x indicates a higher proportion of the mixture is present as vapor until x=1 at which point the mixture is 100% vapor. Once the 100% vapor point is reached, adding further energy increases the temperature of the working fluid and the vapor is taken from a saturated state to a superheated state with x=1.

The term “parallel” is intended to mean “substantially parallel” and to encompass minor deviations from parallel geometries rather than to require that parallel rows of reflectors, or parallel tubes, for example, or any other parallel arrangements described herein be exactly parallel.

Disclosed herein are systems, methods, and apparatus by which solar energy may be collected as heat and used for heating a working fluid (e.g., water/steam). Some of the disclosed systems, methods, and apparatus relate to potentially advantageous arrangements of solar heating systems in order to increase the quality and/or temperature of a working fluid. Examples of such arrangements are given below primarily in the context of specific example solar energy concentration systems, including linear Fresnel reflector solar energy collectors and parabolic trough collectors systems. It should be understood, however, that any suitable systems, methods, and apparatus for concentrating solar radiation known to one of ordinary skill in the art or later developed may be used in combination with the disclosed arrangements of working fluid and heat transfer fluid, and heat transfer between said fluids. For example, other types of concentrating solar heating systems, such as those in which heliostats direct sunlight to a tower receiver, dish concentrating systems, and other systems, or combination of such systems, may be utilized.

Additionally, although the working fluid is identified as water/steam in variations described below, any suitable alternative heat absorbing fluid(s) may also be used, provided that the working fluid may be present as a vapor at operating temperatures of at least a portion of the system. Example alternative fluids for use as the working fluid may include, but are not limited to, ammonia, ammonia-water mixtures, gases (e.g., air, helium, propane, isopentane, CO₂), refrigerants (e.g., R134A), and synthetic heat transfer fluids (including synthetic heat transfer fluids that may change phase from liquid to gas phase under the operating conditions of the solar absorber in which they are used). As used herein, a “synthetic heat transfer fluid(s)” indicates a type of fluid material (e.g., a composition) rather than the location of the system in which it may be used. Thus, a “synthetic heat transfer fluid(s)” may be used as a working fluid and/or as a heat transfer fluid, provided that it is suitable for use in the context of that particular system.

In addition, while the heat transfer fluid is identified in the variations below as an oil (e.g., a naturally occurring or synthetic oil such as mineral oil or silicon-containing oil such as silicone oil) or as a synthetic heat transfer fluid (such as those based on phthalate esters, alkylated aromatics, partially hydrogenated terphenyls, dipheny/diphenyl oxide blends, or silicone-based synthetic heat transfer fluids), any suitable alternative heat absorbing fluid(s) may also be used. Example fluids for use as the heat transfer fluid may include, but are not limited to, water, oils (naturally occurring and/or synthetic), molten salts, room temperature ionic liquids (e.g., alkylmethylimidazolium), gases (e.g., air, helium, propane, isopentane, CO₂), refrigerants (e.g., R134A) and synthetic heat transfer fluids. Examples of synthetic heat transfer fluids include the Therminol® family of heat transfer fluids available from Solutia, the DowTherm® family of heat transfer fluids available from Dow Chemical Co., and the Syltherm® family of silicone-based heat transfer fluids available from Dow Corning Corp.

Further, some variations are described in the context of producing saturated steam in a first solar heating system, optionally separating out at least some of the remaining liquid, and then further heating the steam via heat exchange from the heat transfer fluid that has been heated by a second solar heating system to produce superheated steam. However, it is to be understood that this is merely one variation, and that the first solar heating system may produce saturated and/or superheated working fluid, and the working fluid is then increased in quality and/or temperature by heat exchange from the heat transfer fluid heated by a second solar heating system. These variations may be used in combination with any of the systems as described herein. For example, saturated steam at a quality x₁ may be produced by the first solar heating system, which then absorbs heat in the heat exchanger, resulting in a saturated steam of higher quality x₂, wherein x₂>x₁. In another example, saturated steam at quality x₁ (where x₁<1) and temperature t₁ may be produced by the first solar heating system, which then absorbs heat in the heat exchanger, resulting in superheated steam having a quality x₂=1 and a temperature t₂, wherein t₂>t₁. In another example, saturated steam at quality x₁ (where x₁=1) and temperature t₁ may be produced by the first solar heating system, which then absorbs heat in the heat exchanger, resulting in superheated steam having a quality x₂ and a temperature t₂, wherein x₂=x₁=1 and t₂>t₁. In another example, superheated steam at temperature t₁ may be produced by the first solar heating system, which then absorbs heat in the heat exchanger, resulting in a superheated steam having a temperature t₂, wherein t₂>t₁. Further, the particular quality and/or temperature of the working fluid produced at various locations in the system may be constant over a particular time period, or may vary over time, for example, depending upon the time of day, the presence of cloud cover or other weather condition, the configuration and particular usage of the system, etc.

The optional separator may be used in any of the examples described herein, to separate at least some of any liquid remaining in the heated working fluid produced by the first solar heating system. For example, the separator may remove all (i.e. resulting in a quality x=1) or substantially all liquid remaining in the heated working fluid. Removal of substantially all liquid from the working fluid indicates, in various embodiments, that at least about 90%, at least about 92%, at least about 94%, at least about 96%, at least about 98%, or at least about 99% of the liquid present in the heated working fluid from the first solar heating system has been removed by the separator. In various embodiments, removal of substantially all liquid from the working fluid indicates that the working fluid output from the separator has a quality of at least about 0.9, at least about 0.93, at least about 0.95, at least about 0.96, at least about 0.97, at least about 0.98, at least about 0.99.

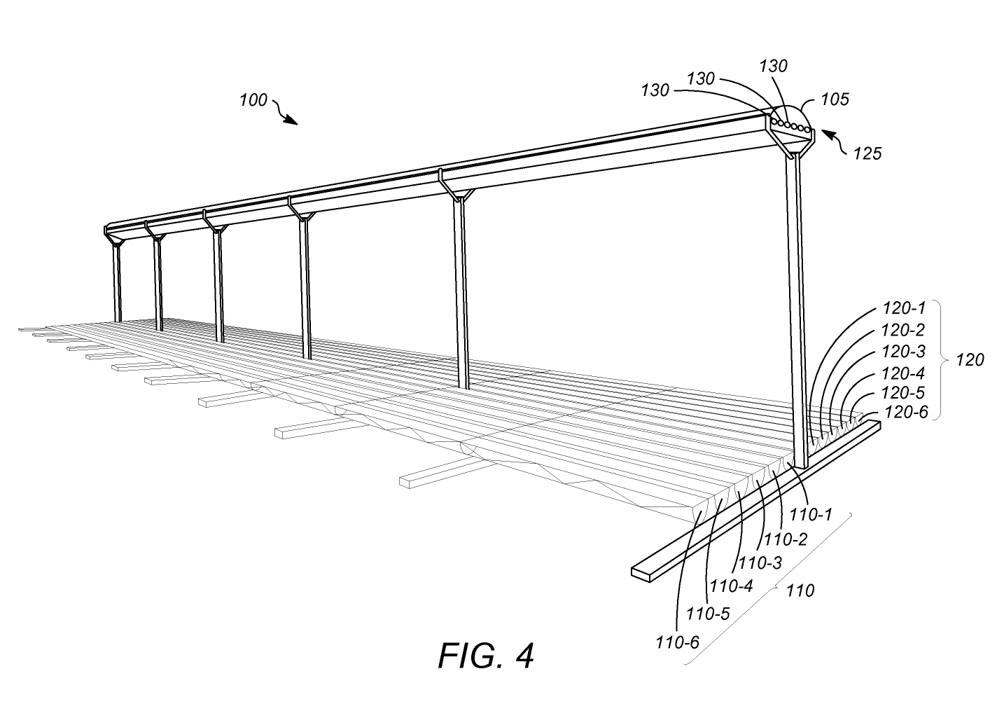

Further, while the various embodiments are described below in the context of separate first and second solar heating systems, it is to be understood that a single system may comprise the first and second solar heating systems (e.g., a single system may comprise the fluid circuits for both the first and second solar heating systems). In one non-limiting example, a CLFR system (e.g., as depicted in FIG. 4) may comprise a fluid circuit for heating the working fluid within the receiver, as well as a fluid circuit for heating the heat transfer fluid. In some embodiments, the first and second solar heating systems are separate. In some embodiments, a single solar heating system comprises both the first and second solar heating systems for heating the working fluid and heat transfer fluid, respectively.

Additionally, while some variations described below are described in the context or absence of a turbine (and optional coupled electrical generator), it is to be understood that any of the systems described herein may be used for production of vaporous working fluid for direct use (e.g., use of industrial process steam), or may include one or more turbines or other apparatus, e.g., for generation of electrical power.

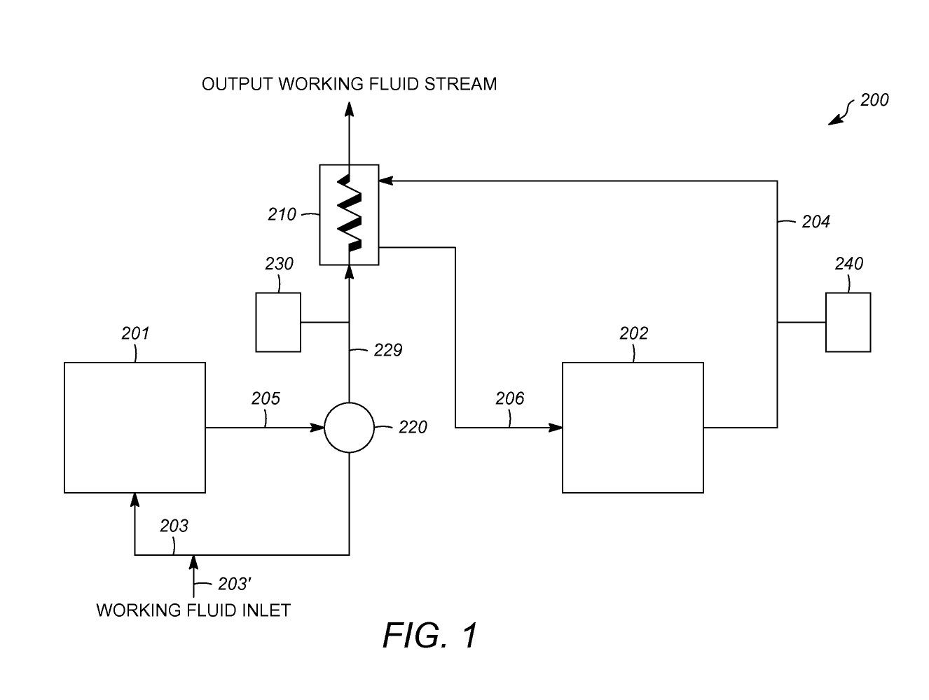

Referring now to FIG. 1, which shows one variation of a system 200 for producing a vaporous working fluid, comprising a first solar heating system 201, a second solar heating system 202, a heat exchanger 210, and (optionally) a separator 220 situated between the first and second solar heating systems. Fluid passage 203 conveys a working fluid (such as water) to the first solar heating system 201, where the water is heated to produce steam. The working fluid may be directed into fluid passage 203 through one or more sources, for example, as a recycled working fluid stream from a variety of locations within the system and/or a fresh working fluid stream. For example, a working fluid inlet 203′ for directing fresh working fluid into the system may be connected to fluid passage 203. In another example, described in more detail below, recycled working fluid may be directed to fluid passage 203 from the separator 220. In various embodiments, the heating system 201 may have one or more sections for increasing the temperature of the water (economizer sections, for adding sensible heat), for boiling saturated water to generate steam (boiler or evaporator sections, for adding latent heat), and for superheating the steam (for adding sensible heat). In one variation, the heating system 201 acts to preheat the water and produce saturated steam. In one variation, the input water is preheated, and the heating system 201 produces saturated steam. In some variations, most of the heat is transferred to the working fluid as latent heat within the heating system 201. In one example, the first solar heating system comprises a linear Fresnel solar heating system, which may use a multi-tube solar receiver, such as those described in U.S. patent application Ser. Nos. 10/597,966 or 12/012,829, each of which is incorporated herein by reference, or a single tube solar receiver, such as those described in U.S. Patent Publication US 2004/0035111, which is incorporated herein by reference. In some instances, the first solar heating system may include a non-solar fueled boiler (e.g., natural gas fired boiler, a coal fired boiler, or a biomass fired boiler) in parallel or series with a solar boiler.

In various embodiments, the resulting heated working fluid may be saturated (in which case both vapor (e.g., steam) and liquid (e.g., water) are present), or may be superheated (wherein only steam is present). The heated working fluid output is conveyed by a fluid passage 205 to an optional separator 220, where at least a portion of the liquid is separated from the vapor, and the liquid (e.g., water) is returned to the fluid passage 203. The resulting working fluid is enriched in vapor, and thus the quality of the working fluid is increased. In some embodiments, the vapor is substantially separated from the liquid by the separator 220, resulting in superheated or close to superheated vapor prior to entering the heat exchanger 210. The working fluid including steam and optional remaining water is directed to the heat exchanger 210 through fluid passage 229, wherein heat from the heated heat transfer fluid is transferred to the working fluid, resulting in increased quality and/or temperature for the output working fluid stream. In some variations, the heat transfer results in an increase in quality. In some variations, the heat transfer results in an increase in temperature. In some variations, the heat transfer results in an increase in quality and temperature. In some variations, most of the heat is transferred to the working fluid as sensible heat, increasing the temperature of the superheated vapor (e.g., superheated steam).

Note that in the example just described and in the examples below, associations of particular heat absorption processes (e.g., heating liquid water, boiling water, superheating steam) with particular regions of a solar heating system and/or heat exchanger are intended to refer to steady state operation of the system. Such associations may not necessarily hold during transient conditions, such as, for example, at start-up, at shutdown, and when clouds interrupt or diminish the solar flux.

Still referring to FIG. 1, the heat transfer fluid (e.g., oil or synthetic heat transfer fluid) is conveyed by a fluid passage 206 to a second solar energy heating system 202, where the heat transfer fluid is heated, typically to a temperature greater than the heat of vaporization of the working fluid at the particular operating pressure of the working fluid (e.g., 100° C. for water at 1 atm). The heated heat transfer fluid is directed by fluid passage 204 to the heat exchanger 210, where the heat transfer fluid transfers heat to the working fluid, thus increasing the quality and/or temperature of the working fluid, and then is returned to fluid passage 206 for reheating by the second solar energy heating system 202. In one example, the second solar heating system comprises a parabolic trough system. In some variations, the second solar heating system may comprise a non-solar fueled boiler (e.g., a natural gas fired boiler, a coal fired boiler, or a biomass fired boiler) in series or parallel with a solar boiler.

The output working fluid stream from the heat exchanger may either be saturated or superheated. The resulting output working fluid stream may be used directly in industrial applications (e.g., as process steam), and/or may be directed to a turbine for electrical power generation. Industrial applications include generation of steam or heat for cleaning or sterilization, enhanced oil recovery, pulp and paper processing, agricultural processing, food processing, refrigeration, petrochemical refining and processing, and desalination.

While FIG. 1 shows a separator 220, the separator is not required, and is an optional component of the systems disclosed herein. In some variations, the heated working fluid from the first solar heating system 201 may be directed to the heat exchanger without passing through a separator. Optionally, the system may further comprise one or more thermal energy storage systems, for example, a thermal energy storage system 230, for storing energy from the heated working fluid, or for example, a thermal energy storage system 240, for storing energy from the heat transfer fluid. Thermal energy storage systems may be used, for example, to manage differences in the relative energy capture capabilities of the different solar heating systems, as buffers against transient demands that exceed the steady state output capacities of plants, against temporary reduction in input heat or, alternatively, to provide long term thermal energy storage when heat generating capabilities cannot, for various reasons, be synchronized with load demands.

The system 200 may further comprise components in addition to those shown, e.g., reservoirs, valves, and other devices for accommodating and controlling the flow of fluid through the system. For example, one or more pumps may be provided at various positions in the system 200 for circulating the working fluid and/or heat transfer fluid. The operation of the system 200 can be manipulated by a controller, such as a computer or other processing device, and may be facilitated by various monitoring systems (e.g., to monitor temperature, pressure, flow rate, etc.) at various positions throughout the system. One of ordinary skill in the art would appreciate that various other components useful in operating and/or maintaining the system may be included, and need not be described herein. These components may be present, for example, within a solar energy heating system, or at other positions in the system 200, as will be apparent to one of ordinary skill in the art. For example, with reference to FIG. 4 as will be described in more detail below, fluid (e.g., water, steam, and superheated steam) flow rates through tubes 130 may be controlled, for example, with valves and/or orifice plates in the tubes 130. Flow rates through tubes 130 may be controlled with the valves and/or orifice plates, for example, to provide a desired steam quality and/or temperature (e.g., quality of saturated steam, temperature and/or pressure of superheated steam) in the output working fluid.

The solar heating systems may comprise any suitable system for concentrating and collecting solar energy, such as a linear Fresnel, parabolic trough, tower/central receiver and heliostat systems, dish systems, etc., and may be comprised of one or more types of solar heating systems. Linear Fresnel, parabolic troughs, tower/heliostat, and dish systems are known in the art and need not be described herein. In addition, each solar heating system may further comprise a non-solar booster or parallel non-solar heating system, for example, a fossil-fueled boiler.

As will be apparent to those of ordinary skill in the art, the operating temperatures and pressures of the working fluid circuit and the heat transfer circuit will vary depending upon the particular working fluid and heat transfer fluids used, the type(s) of solar heating systems, the desired final quality and temperature of the working fluid output, the intended use of the working fluid output, the particular configuration of the system, and the like. When water is the working fluid, typical operating pressures will range from about 20 to about 200 bar, for example, from about 20 to about 100 bar, and typical operating temperatures for the working fluid will range from about 200° C. to about 600° C., for example, about 200° C. to about 565° C., for example, about 200° C. to about 370° C. Typically, the heat transfer fluid is heated within the second solar heating system 202 to a temperature higher than that of the heated working fluid output from the first solar heating system 201, in order to increase the quality and/or temperature of the working fluid upon heat exchange. Typical operating temperatures for the heat transfer fluid will be 10° C. to 20° C. higher than the corresponding working fluid temperatures to allow for heat transfer from the heat transfer fluid to the working fluid. Heat transfer fluid pressures will vary based on the properties of the particular heat transfer fluid but will be generally lower (<40 bar) by design.

In some embodiments, when water is used as the working fluid, the desired operating pressure for the working fluid is about 100 bar to about 170 bar at the output, for example, about 100 bar. In some embodiments, the first solar heating system heats the working fluid to the saturation temperature of about 325° C. at 120 bar. After heat exchange with the heat transfer fluid and transport to the turbine inlet, the working fluid may be at a temperature of, for example, about 370° C. at 100 bar. At 100 bar pressure, often about 82% of the total energy input into the water/steam working fluid will be at the stage of the first solar energy heating system, and about 18% of the total energy input into the water/steam working fluid will be at the second heating stage of the heat exchanger. The relative ratios of energy input into the working fluid at the first and second stages of heating may vary as the operating pressures change. Additionally, use of different working and/or heat exchange fluids may also affect this ratio.

In various embodiments, the quality of the working fluid output from the first solar heating system 201 is at least about 0.3, at least about 0.4, at least about 0.5, at least about 0.6, at least about 0.7, at least about 0.8, at least about 0.9, about 1.0. In some embodiments, the quality of the working fluid output from the first solar heating system 201 is at least about 0.5. In some embodiments, the quality of the working fluid output from the first solar heating system 201 is at least about 0.6. In various embodiments, the quality of the working fluid output from the separator 220 is at least about 0.5, at least about 0.6, at least about 0.7, at least about 0.8, at least about 0.9, at least about 0.95, at least about 0.98, about 1.0. In some embodiments, the quality of the working fluid output from the separator 220 is at least about 0.9. In some embodiments, the quality of the working fluid output from the separator 220 is about 1.0. In various embodiments, the quality of the working fluid output from the heat exchanger is at least about 0.5, at least about 0.6, at least about 0.7, at least about 0.8, at least about 0.9, at least about 0.95, at least about 0.98, about 1.0. In some embodiments, the quality of the working fluid output from the heat exchanger is at least about 0.95. In some embodiments, the quality of the working fluid output from the heat exchanger is at least about 0.98. In some embodiments, the quality of the working fluid output from the heat exchanger is about 1.0.

In some embodiments, when water is the working fluid, the temperature of the working fluid output from the heat exchanger is about 310° C. to about 600° C., for example, about 350° C. to about 450° C. In some embodiments, when water is the working fluid, the temperature of the working fluid output from the heat exchanger is at least about 370° C. In some embodiments, superheated steam generated by the system may have, for example, a temperature of about 300° C. to about 450° C. and a pressure of about 70 bar to about 130 bar, or a temperature of about 370° C. to about 450° C. and a pressure of about 100 bar to about 130 bar. In some variations the superheated steam has a temperature of about 450° C. and a pressure of about 130 bar.

As noted above, in various applications, it is preferred to have a higher quality and/or temperature of vaporous working fluid. For example, turbines (e.g., for electrical generation) may be more efficiently powered by higher temperature superheated steam than by lower temperature steam. Such superheated turbines are also smaller and less costly than saturated turbines that make equivalent output power. However, existing technologies for producing a continuous output of sufficient superheated vapor can be relatively expensive, thus reducing the practicality of the technology for use on an industrial scale. The present technology advantageously permits production of a vaporous working fluid at a high quality and/or temperature, and in some embodiments may allow for a higher quality and/or temperature (e.g., more degrees of superheat) of working fluid to be produced at a relatively lower cost than existing technologies.

As an illustrative example, when water is used as a working fluid, considerable energy must be added to the water in order to generate superheated steam, since the water must first be entirely converted to steam (as latent heat) before the temperature of the steam can be increased (as sensible heat). Such latent heating may be more cost-effectively performed by directly heating the working fluid in the first solar heating system. On the other hand, it may be easier to control the temperature of superheated steam within the operating margins of an industrial process (such as a steam turbine), using indirect heating via a heat transfer fluid. One possibility for heating water to superheated steam is to heat a sensible heating fluid such as an oil or synthetic heat transfer fluid using a solar energy heating system, wherein the sensible heating fluid is heated to a temperature higher than the heat of vaporization of water, and wherein the heat is transferred from the sensible heating fluid to the water/steam via a heat exchanger. However, heating fluids such as oil or synthetic heating fluid used in a solar energy heating system is relatively expensive, and thus using heated heat transfer fluid as the primary source for evaporating water is relatively more expensive. In contrast, water is relatively less expensive to heat directly using a solar energy heating system. However, it can be difficult and/or expensive to use solar energy as the sole heating source for the water/steam.

The present technology advantageously permits a substantial portion of total heat energy input into the working fluid at a relatively lower cost, and utilizes the relatively more expensive technology (such as solar heating of a heat transfer fluid such as oil or synthetic heat transfer fluid) for only a portion of the total energy input. For example, the water may initially be heated (e.g., to a temperature in which it remains saturated) directly by a solar heating system, producing a working fluid of a quality x₁. The quality of the working fluid may optionally be increased by use of a separator to remove at least a portion of the remaining liquid (e.g., resulting in a working fluid with reduced liquid content), resulting in a working fluid having a higher quality x₁′. The working fluid is then heated at a second stage by heat transfer from a heated heat transfer fluid. In this example, the heat transfer fluid is oil or a synthetic heat transfer fluid, which is heated to a high temperature (e.g., about 393° C.) using a solar energy heating system. This heat transfer boosts the quality and/or temperature of the working fluid to a higher quality x₂ and/or higher temperature t₂, resulting in, for example, saturated steam of a higher quality, superheated steam, or superheated steam of a higher temperature. The heat transfer fluid may be a sensible solar heating fluid, which does not undergo a phase change at the operating temperatures of the system, such as oils, molten salts, synthetic heat transfer fluids, etc. These fluids may be more readily heated to a higher temperature using a solar heating system, since the heat energy is added as sensible heat to the fluid (whereas a fluid that changes phase at the operating temperature will absorb heat as latent heat, which will not raise the temperature of the fluid). Further, in some embodiments, the working and/or heat transfer fluid may be heated using linear Fresnel technology, which may be cheaper to build and operate than parabolic trough technology or other technologies such as heliostat systems.

For example, Fresnel systems offer concentration ratios similar to those of trough systems, but without heat-sagged high curvature mirrors or evacuated tube heat collection elements. The flat float-glass minors that may be curved slightly by mechanical means in the Fresnel system may be less than half the cost of the heat sagged parabolic trough minors. Fresnel systems additionally may use downward facing inverted cavity receivers and air stable selective surfaces that do not require a vacuum to minimize convective losses and protect the selective surface from oxidation.

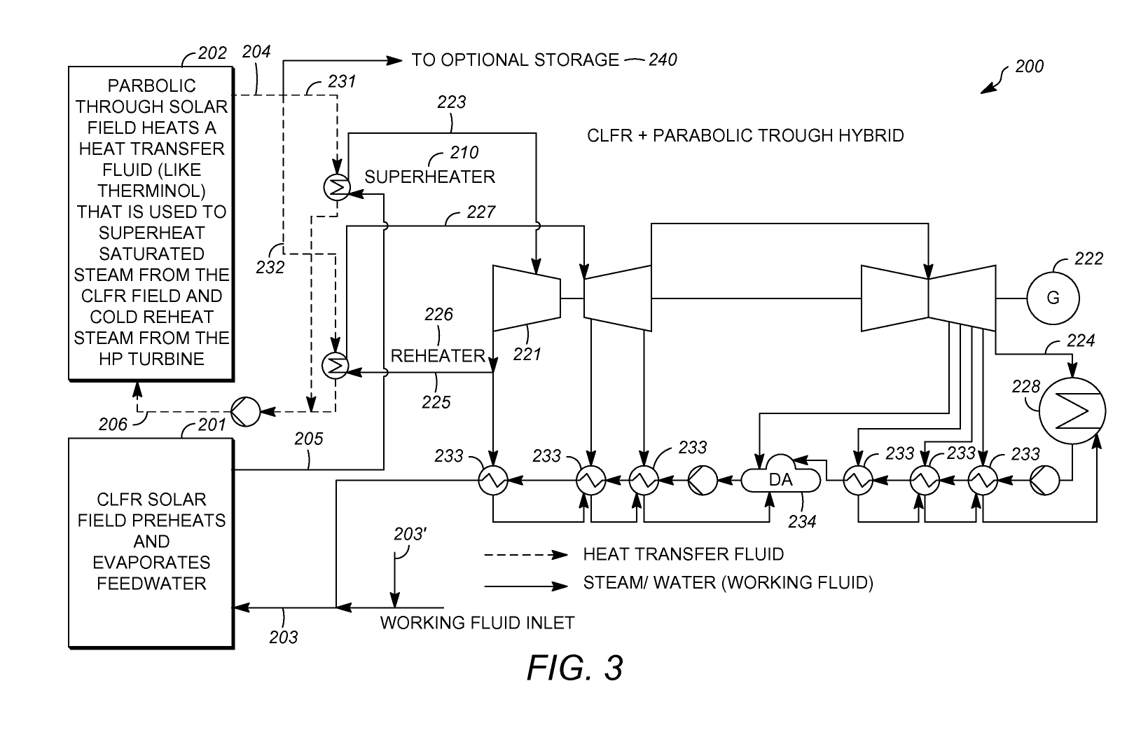

As described in more detail below with reference to FIG. 3, a reheater heat exchanger may optionally be used, wherein the working fluid (e.g., superheated steam), after having passed through a portion of a turbine and been partially cooled, may be reheated by the heated heat transfer fluid before being returned to the turbine. For example, the heated heat transfer fluid may transfer sensible heat to the partially cooled working fluid, raising it back to the same temperature as it was at the input of the turbine. Having the reheat temperature in the power cycle the same as the main inlet temperature increases the conversion efficiency. This may not be practical in an all direct steam system, because the pressure loss experienced by conveying the partially expanded steam back to and through the solar heating system may counteract the benefit of higher temperature steam. In contrast, the heat exchanger may be located close to the discharge of the high pressure steam turbine, reducing the pressure loss experienced by the partially expanded steam.

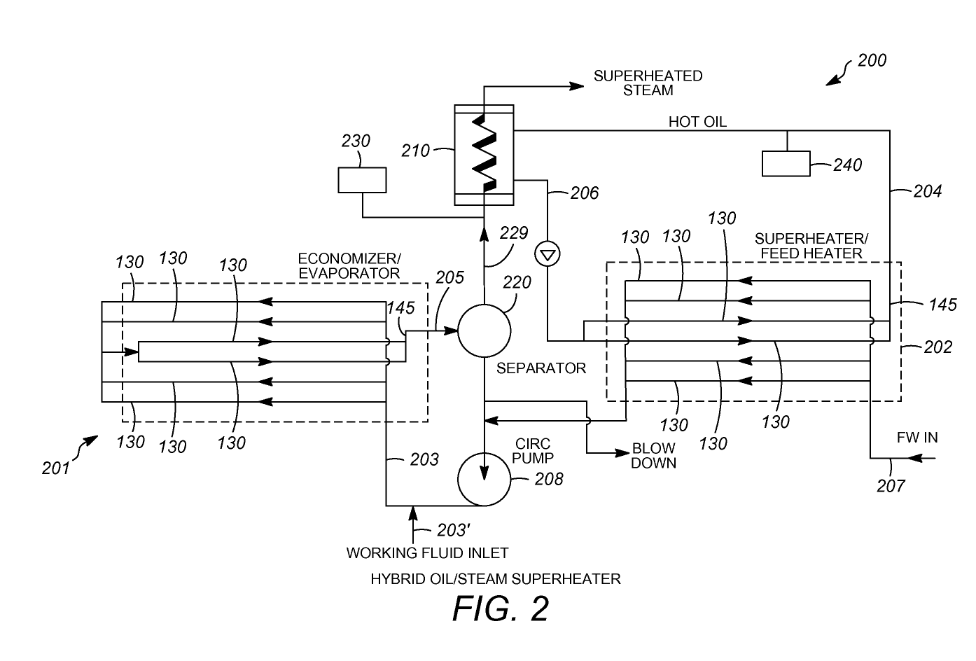

Another variation is shown in FIG. 2. In FIG. 2, the first and second solar heating systems are linear Fresnel solar heating systems, with the Figure indicating a schematic for one example of fluid flow through the heating systems 201 and 202. FIG. 4 depicts one non-limiting variation of a linear Fresnel solar heating system, in which a linear Fresnel reflector solar energy collector 100 comprises reflector fields 110 and 120 disposed on opposite sides of an elevated linear extending solar thermal receiver 105. Reflector fields 110 and 120 comprise, respectively, reflector rows 110-1 - 110-6 and 120-1 - 120-6. The angular orientation of the reflectors may be adjusted around their long axes to track the sun's apparent motion during the day to reflect solar radiation to solar thermal receiver 105.

One of ordinary skill in the art will understand that linear Fresnel collectors are known in the art, and that features of the support structures and the general arrangement of the reflectors with respect to the linear Fresnel solar energy collector in FIG. 4 are intended as schematic illustrations representing numerous configurations known in the art. Suitable linear Fresnel systems may include, but are not limited to, those disclosed in U.S. patent application Ser. No. 10/597,966 titled “Multi-Tube Solar collector Structure,” filed Aug. 14, 2006, U.S. patent application Ser. No. 12/012,821 titled “Linear Fresnel Solar Arrays and Drives Therefor,” filed Feb. 5, 2008, U.S. patent application Ser. No. 12/012,829 titled “Linear Fresnel Solar Arrays and Receivers Therefor,” filed Feb. 5, 2008, and U.S. patent application Ser. No. 12/012,920 titled “Linear Fresnel Solar Arrays and Components Therefor,” filed Feb. 5, 2008, all of which are incorporated by reference herein in their entirety.

Referring again to FIG. 4, solar thermal receiver 105 includes a solar thermal absorber 125 comprising a plurality of parallel tubes 130 arranged in a side-by-side manner. A heat absorbing working fluid (e.g., water) passed through tubes 130 may be heated by solar radiation concentrated onto thermal absorber 125. In some variations, solar thermal receiver 105 may have an inverted trough type structure as described, for example, in the patent applications referred to above. Solar thermal receiver 105 may further comprise, in some variations, reflective surfaces which reflect light incident on them from minor fields 110 and/or 120 to tubes 130.

The tube diameters may also be selected to minimize the amount of metal used and/or to minimize the volume of water that can exist in tubes 130. Tube diameters may also be selected to minimize fluid transit time through all, or portions, of tubes 130, such as through evaporating and superheating portions, for example, to provide a faster response of fluid flow rate to controls.

In some variations, the materials from which various tubes of tubes 130 (in examples described above or below herein) are formed may vary depending on the heat absorbing fluid process that occurs within them. For example, in some variations economizer and boiler tubes (or partial portions of tubes in which boiling may occur) may be formed from carbon steel and superheating tubes (or partial portions of tubes in which superheating is expected to occur) may be formed from T22 or similar low alloy steel. T22 or similar material may allow superheated steam temperatures up to about 1000° F., in some variations. Also, in some variations, solar selective coatings may be used on the tubes 130.

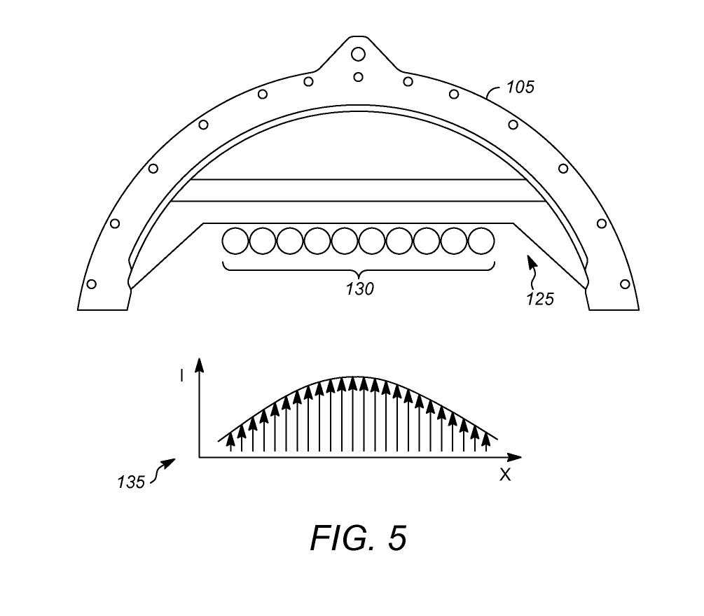

Referring now to FIG. 2, the Figure indicates a schematic for one example of fluid flow through the heating systems 201 and 202. Thus, FIG. 2 illustrates one non-limiting example of working fluid flow through a linear Fresnel receiver, e.g., receiver 105 according to FIG. 4. In the example shown in FIG. 2, water is directed into the linear Fresnel system receiver 105 by fluid passage 203, wherein it flows into the outer four tubes 130, travels to the end of the receiver structure, and returns through the inner two tubes 130 of the receiver 105 before exiting the solar energy heating system through outlet header 145 to fluid passage 205. In such variations, the enthalpy of the fluid in the outer (peripheral) tubes 130 is initially approximately the same, and is then increased as the fluid absorbs heat during its passage through the tubes, so that outgoing fluid from the centrally located tubes has effectively undergone a double pass through the illuminated region of the receiver. It will be appreciated by one of ordinary skill in the art that this schematic merely illustrates one possible configuration for fluid flow through a receiver 105, and that other configurations are possible and encompassed by the present technology. For example, receiver tubes 130 may be organized in series, in parallel, counter-parallel, serpentine, or other configuration or combination of two of more of these configurations. Additionally, the receiver depicted in FIG. 4 illustrates a multi-tube receiver. The number of tubes 130 in the multi-tube receiver 105 may be varied. In some examples, the number of tubes 130 in the receiver 105 are from about 3 to about 40. Single-tube receivers may also be used. As will be discussed in more detail below with regards to FIG. 5, the working fluid flow depicted in FIG. 2 may advantageously utilize peak solar power distribution for a particular receiver structure.

After exiting from the first solar heating system 201, the heated working fluid may optionally be directed to a separator 220 prior to the heat exchanger 210. The separator 220 preferentially separates liquid from the vapor, and the separated liquid may be, for example, redirected back to fluid passage 203 for reheating. A circulation pump 208 for circulating the working fluid is shown; variations of this configuration will be apparent to one of skill in the art.

In this variation shown in FIG. 2, the second solar heating system 202 comprises a linear Fresnel system. Working fluid (e.g., water) enters the linear Fresnel solar heating system 202 via a fluid passage 207, and the water flows into the outer (peripheral) four tubes 130, travels to the end of the receiver structure, and is directed into the fluid passage 203 for delivering the working fluid to the first solar heating system 201. This configuration permits preheating (e.g., adding sensible and optionally latent heat) of the working fluid by the second solar heating system 202, with the preheated working fluid then directed to the first solar heating system 201 for further heating (e.g., vaporization and optionally superheating). In some embodiments, the working fluid heated by the second solar heating system 202 may be directly delivered to the separator 220, with the separated liquid directed, for example, into fluid passage 203. Optionally, the system may comprise a thermal energy storage system 230 for storage of thermal energy from the heated working fluid.

The heat transfer fluid (in this variation, oil) enters the second solar heating system 202 via fluid passage 206, wherein it is directed through the inner high solar concentration two tubes 130 before exiting the solar energy heating system via fluid passage 204. It will be appreciated by one of ordinary skill in the art that this schematic merely illustrates one possible configuration for fluid flow through a receiver 105, and that other configurations are possible and encompassed by the present technology. For example, the number of tubes 130 may be varied (for example, one or more (e.g., two, three, four, etc) tubes for heat transfer fluid (e.g., oil), and one or more (e.g., two, three, four, etc) tubes for the working fluid (e.g., water)), the tubes 130 may be arranged in series, in parallel, counter-parallel, serpentine, or other configuration or combination of two of more of these configurations. This configuration may permit the peak power distribution of the solar energy entering the receiver 105 in the second solar heating system 202 to be directed preferentially to the oil, as discussed in more detail with reference to FIG. 5.

Referring now to FIG. 5, plot 135 shows an example intensity (“I”) distribution of solar radiation concentrated at solar thermal absorber 125 along a direction (“X”) transverse (perpendicular) to the long axis of solar thermal receiver 105. Solar thermal receiver 105 is shown in cross section along the same X direction. In the illustrated example, the transverse solar radiation intensity distribution, and consequently the distribution of the heat flux into tubes 130, has a maximum (e.g., a central peak). The reflectors can be arranged so that the heat flux into the tubes is thus greater at or near the center-most tube or tubes than at the two outer-most tubes (in the example of the FIG. 5, the tube farthest to the right and the tube farthest to the left). The solar radiation intensity distribution along the long axis of solar thermal receiver 105 (i.e., the longitudinal solar radiation intensity distribution) may be, for example, substantially constant. As will be apparent to one of skill in the art, depending on the particular receiver structure utilized, the peak power distribution may differ, and the arrangement of tubes may be varied accordingly depending on the desired result for the particular working fluid and particular heat transfer fluid used. Note that although FIG. 5 shows 10 tubes 130, the methods, systems, and apparatus disclosed herein may use either more or fewer than 10 tubes as suitable. Also, although tubes 130 are shown as lying in a plane, in other variations parallel tubes 130 may be arranged side-by-side in two or more parallel or intersecting planes. Two such intersecting planes may form, for example a chevron shape or an inverted chevron shape.

In some variations of this and of other fluid flow path arrangements disclosed herein, temperature measurements may be made at various points throughout the receiver tubes 130 to aid in controlling fluid flow rates through tubes 130. For example, if a temperature measurement on what is expected or intended to be a superheating side of a boiler/superheat boundary has a value corresponding to liquid water, the flow rate through the tubes in which that boundary occurs may be decreased. Alternatively, if a temperature measurement on what is expected to be a boiler side of a superheating/boiler boundary corresponds to superheated steam, the flow rate through the tubes in which that boundary occurs may be increased. Additionally or alternatively, fluid flow may be controlled using any suitable temperature and/or pressure measurements made elsewhere among tubes 130. Such additional or alternative control schemes may include or be similar to, but are not limited to, those disclosed in U.S. Patent Application Ser. No. 61/216,253, titled “Systems and Methods for Producing Steam Using Solar Radiation,” filed May 15, 2009, incorporated herein by reference in its entirety and/or those disclosed in U.S. Patent Application Ser. No. 61/216,878, also titled “Systems and Methods for Producing Steam Using Solar Radiation,” filed May 22, 2009, incorporated herein by reference in its entirety. In some variations in which superheated steam is generated within the solar heating system(s), the temperature of the superheated steam is measured at the outlet of any tube through which the superheated steam exits tubes 130. The measured temperature may be used, for example, to provide feedback for control valves controlling fluid flow through the superheating steam tube or tubes. Fluid flow control schemes identical to or substantially similar to those so far disclosed in this specification (including use of valves, orifices, and temperature and pressure measurements) may also be used, in some variations, to control fluid flow through tubes in the solar heating system(s) described herein.

Referring to solar heating system 202 in FIG. 2, in which heat transfer fluid such as oil or synthetic heat transfer fluid flows though the center two tubes 130, and water flows through the outer four tubes 130 (two on each side), the tubes are illuminated with solar radiation having an intensity distribution shaped similarly to that of FIG. 5. In such variations, the heat flux distribution into tubes 130 may heat water flowing through tubes 130 to increase its temperature under relatively low heat flux (compared to the peak heat flux provided by the concentrated solar radiation) in outer ones of tubes 130, and the oil is heated under relatively higher heat flux in the tubes nearer to the center of tubes 130.

Similarly, referring to solar heating system 201 in FIG. 2, in which water flows first though the outside four tubes 130 (two on each side), and then flows through the inner two tubes 130, the tubes are illuminated with solar radiation having an intensity distribution shaped similarly to that of FIG. 5. In some variations, the heat flux distribution into tubes 130 may heat water flowing through tubes 130 to increase its temperature under relatively low heat flux (compared to the peak heat flux provided by the concentrated solar radiation) in outer ones of tubes 130, then boil the liquid water to generate steam under relatively higher heat flux in tubes nearer to the center of tubes 130. In some embodiments (not shown in FIG. 2), an additional set of tubes 130 placed at the location of the highest heat flux may then optionally superheat the steam at comparable or relatively higher heat flux in the center-most tube or tubes of tubes 130. It is to be understood that these variations are merely examples, and the locations at which the water or other working fluid is increased in temperature, vaporizes, and/or where the steam becomes superheated may be varied.

In some variations in which the fluid flow path or paths make two passes (i.e., down and back) along tubes 130, such as the example shown in FIG. 2, a solar thermal receiver supporting such a flow path or paths may be inclined (e.g., the solar thermal receiver may be located on sloping ground) with tubes 130 oriented so that water in tubes 130 flows downhill and steam in tubes 130 flows uphill.

The oil heated by solar heating system 202 exits from the tubes 130 through outlet header 145, and enters the fluid passage 204, where it is directed to the heat exchanger 210 for further heating of the working fluid. Optionally, the system may comprise a thermal energy storage system 240 for storage of thermal energy from the heated oil.

FIG. 3 shows another non-limiting example of a system. In this example, the first solar heating system 201 is a compact linear Fresnel reflector (CLFR) system which preheats and evaporates the working fluid (e.g., water), generating saturated vapor (e.g., steam). The second solar heating system 202 is a parabolic trough system for heating the heat transfer fluid (e.g., Therminol®). The heated heat transfer fluid superheats the steam from the CLFR field via heat exchanger 210, and the superheated steam is directed by fluid passage 223 to turbine 221 for rotating the turbine and generating electricity via coupled electrical generator 222. Expended working fluid exits the turbine 221 via fluid passage 224, where it may be condensed at condenser 228, preheated and deaerated by a series of steam extracting feedwater heaters 233 and a deaerator 234, and then returned to the CLFR system for further preheating and evaporation. Preheating the working fluid prior to entry into the solar heating system 201 may increase the overall efficiency of heat absorption within the system, since it permits addition of heat into the working fluid at smaller temperature differences throughout the system.

In some variations, an example of which is shown in FIG. 3, working fluid (e.g., superheated steam) which has partially cooled after passing through a portion of the turbine 221 exits the turbine at fluid passage 225, where it is directed to a reheater heat exchanger 226. The partially cooled working fluid is reheated by the heated heat exchange fluid at reheater heat exchanger 226 and is directed back to the turbine via fluid passage 227 for further passage through turbine 221. In some embodiments, the reheated working fluid may have the same or close to the same (e.g., within about 5° C.) temperature as the working fluid at the turbine inlet, thus increasing the conversion efficiency. In the system shown in FIG. 3, the heat exchanger 210 and reheat heat exchanger 226 are within a single heat transfer fluid circuit. For example, as shown in FIG. 3, heated heat transfer fluid exits the second solar heating system 202 via fluid passage 204, which then splits the heated heat transfer fluid into two parallel fluid passages, fluid passage 231 which directs a portion of the heated heat transfer fluid to the heat exchanger 210, and fluid passage 232 which directs a portion of the heated heat transfer fluid to the reheater heat exchanger 226. The expended heat transfer fluid from both heat exchanger 210 and reheater heat exchanger 226 are both directed back to fluid passage 206 for reheating. In some variations, the fluid circuits for the heat exchanger 210 and reheater heat exchanger 226 are independent from each other, and may utilize the same or different solar heating systems for heating the heat transfer fluids in each circuit.

This disclosure is illustrative and not limiting. Further modifications will be apparent to one skilled in the art in light of this disclosure and are intended to fall within the scope of the appended claims.

1. A system for producing a vaporous working fluid, comprising:
a) a first fluid passage configured to convey a working fluid to a first solar heating system, wherein the first solar heating system heats the working fluid to produce a heated working fluid having a temperature t₁ and a quality x₁;
b) a second fluid passage configured to convey a heat transfer fluid to a second solar heating system to produce a heated heat transfer fluid; and
c) a heat exchanger configured to transfer heat from the heated heat transfer fluid to the heated working fluid,
wherein when x₁<1, the heat transfer results in an increase in quality of the heated working fluid to a quality x₂, wherein x₂>x₁; and
wherein when x₁=1, the heat transfer results in an increase in the temperature of the heated working fluid to a temperature t₂, wherein t₂>t₁.

2. The system of claim 1, further comprising a separator located in circuit between the first solar heating system and the heat exchanger,
wherein the separator is configured to receive the heated working fluid having quality x₁ from the first solar heating system,
wherein the separator separates at least a portion of the liquid working fluid, if present, from the heated working fluid, whereby the quality of the heated working fluid is increased to x₁′; and
wherein the heat exchanger is configured to receive the heated working fluid having quality x₁′ from the separator and operates to transfer heat from the heated heat transfer fluid to the heated working fluid,
wherein when x₁′<1, the heat transfer results in an increase in quality of the heated working fluid to a quality x₂, wherein x₂>x₁′; and
wherein when x₁′=1, the heat transfer results in an increase in the temperature of the heated working fluid to a temperature t₂, wherein t₂>t₁.

3. The system of claim 1, wherein the working fluid is water.

4. The system of claim 1, wherein the heat transfer fluid is selected from the group consisting of: an oil, a molten salt, a molten mixture of salts, and an organic synthetic heat transfer fluid.

5. The system of claim 1, wherein the working fluid is water and the heat transfer fluid is an organic synthetic heat transfer fluid.

6. The system of claim 1, wherein the first solar heating system comprises a linear Fresnel solar heating system.

7. The system of claim 1, wherein the second solar heating system comprises a parabolic trough solar heating system.

8. The system of claim 1, wherein the second solar heating system comprises a linear Fresnel solar heating system.

9. The system of claim 1, wherein the first solar heating system and the second solar heating system are the same system.

10. The system of claim 1, wherein the second solar heating system heats the working fluid to produce a preheated working fluid, and wherein the first fluid passage is configured to receive the preheated working fluid.

11. The system of claim 10, wherein the second solar heating system heats the working fluid to produce heated working fluid, and wherein the separator is configured to receive the heated working fluid from the second solar heating system.

12. The system of claim 11, wherein the second solar heating system comprises a linear Fresnel solar heating system comprising a multi-tube receiver comprising a plurality of receiver tubes arranged side by side, wherein one or more receiver tubes configured for carrying the heat transfer fluid, and one or more receiver tubes configured for carrying the working fluid are arranged such that the one or more receiver tubes configured for carrying the heat transfer fluid receive peak solar power distribution during operation of the second solar heating system.

13. The system of claim 1, wherein a first thermal energy storage system is arranged in circuit between the separator and the heat exchanger, and is configured to store thermal energy from the vaporous working fluid.

14. The system of claim 1, wherein a second thermal energy storage system is arranged in circuit between the second solar heating system and the heat exchanger, and is configured to store thermal energy from the heated heat transfer fluid.

15. The system of claim 1, further comprising a turbine, wherein the turbine is configured to receive the superheated working fluid for rotating the turbine.

16. The system of claim 15, wherein after passage through a portion of the turbine, the temperature of the superheated working fluid has fallen to produce a partially cooled working fluid, wherein the system further comprises a fourth fluid passage configured to convey the partially cooled working fluid to a reheater heat exchanger, wherein the reheater heat exchanger is configured to transfer heat from the heated heat transfer fluid to the partially cooled working fluid to produce a reheated working fluid, and wherein the reheated working fluid is delivered to the turbine for rotating the turbine.

17. The system of claim 15, further comprising an electrical generator coupled to the turbine.

18. A method for producing a vaporous working fluid, the method comprising:
a) heating a working fluid with a first solar heating system to produce a first working fluid stream having a quality x₁ and a temperature t₁;
b) heating a heat transfer fluid with a second solar heating system to produce a first heat transfer fluid stream; and
c) transferring heat from the first heat transfer fluid stream to the first working fluid stream;
wherein when x₁<1, the heat transfer results in production of an output working fluid stream having a quality x₂, wherein x₂>x₁; and
wherein when x₁=1, the heat transfer results in production of an output working fluid stream having a temperature t₂, wherein t₂>t₁.

19. The method of claim 18, comprising preferentially selecting vapor from the first working fluid stream to form a second working fluid stream having quality x₁′, and transferring heat from the first heat transfer fluid stream to heat the second working fluid stream,
wherein when x₁′<1, the heat transfer results in an increase in quality of the output working fluid stream to a quality x₂, wherein x₂>x₁′; and
wherein when x₁′=1, the heat transfer results in an increase in the temperature of the heated working fluid to a temperature t₂, wherein t₂>t₁.

20. The method of claim 18, wherein the output vaporous working fluid is superheated steam at a pressure of about 100 bar and about 370° C.
